(19) United States
(12) Patent Application Publication
(10) Pub. No.: US 2012/0158674 A1
(43) Pub. Date: Jun. 21, 2012

(54) Indexing for deduplication

(76) Inventor: Mark David Lillibridge, Mountain View, CA (US)

(21) Appl. No.: 12/973,830

(22) Filed: Dec. 20, 2010

(51) Int. Cl. G06F 17/30

(52) U.S. Cl. 707/692; 707/E17.009

(57) ABSTRACT

Systems and methods of indexing for deduplication are disclosed. An example method includes providing a first table in a first storage and a second table in a second storage. The method also includes looking up a key in the first table. If the key is not found in the first table, the key is looked up in the second table. If the key is found in the second table, the key is copied from the second table to the first table. If the entry is not found or in the second table, an entry with the key is inserted in the first table. The method also includes applying an operation to the entry associated with the key in the first table. The method also includes merging data of the first table with data of the second table when the first table is full to produce a new version of the second table that replaces a previous version.

### BACKGROUND

Some storage devices increase their capacity using deduplication. Deduplication is a known technique which reduces the storage capacity needed to store a given amount of data. An in-line storage deduplication system is, as its name implies, a storage system that does deduplication as data arrives. That is, whenever a block is received with content identical to a block already stored, a new copy of the same content is not made. Instead a reference is made to the existing copy.

In order to do this, a system may use a “logical address to physical address” table and a “block hash to physical address” table. The logical address to physical address table maps the logical addresses that blocks are written to by clients to the actual physical addresses in the store where the contents of the block logically at that address, is physically stored. The block hash to physical address table is used to locate duplicates of received blocks, and may need to handle tens to hundreds of thousands of random lookups, modifications, and/or insertions per second.

Sufficient disk-based storage to handle this operations rate is very expensive. Random access memory (RAM) can handle this operations rate, but the capacity required is expensive. Flash memory (also referred to simply as “flash”), combines high I/O access rates with affordable capacity. Flash does have some drawbacks, such as, flash handles small random writes poorly (slower speed, greater wear). Random writes to flash are substantially slower than random reads or sequential writes to flash.

In addition, random writes particularly increase wear rates in flash. For example, random writes produce far more write amplification than sequential writes. For example, NAND flash only allows erases at the granularity of large groups of pages (about 128 kB total size), so that a single 4 kB write can turn into a 128 kB write. Given that the block hash to physical address table receives a steady stream of updates over time, there is a real danger of wearing out the flash during a product's lifetime if this sort of write amplification is not avoided.

Indices may be implemented in flash by using sequential writes (rather than random writes) by using an “append only” format. That is, entries can be added to the index, but can not be modified or replaced. This approach does not work for deduplication where the block hash to physical address table entries may need to be constantly modified in order to update reference counts to track which blocks are in use and which blocks are “garbage.” Without the ability to remove data that is no longer being used, the storage system implementing deduplication will quickly run out of both disk space and index space.

Other systems which implement flash, batch the index updates in RAM, and then write out the entire batch at once to flash. No effort is made to limit which keys can be in which previous batches, and so looking up a single key may require many flash reads as each previous batch may need to be consulted separately. These systems also only handle a very small number of deletes, and a list of deletes is maintained in RAM.

### BRIEF DESCRIPTION OF THE DRAWINGS

FIG. 1 is a high-level diagram showing an example of a computer system which may use indexing for deduplication.

FIG. 2 shows an example software architecture using indexing for deduplication, which may be implemented in the system shown in FIG. 1.

FIG. 3 is a flowchart illustrating exemplary operations that may be implemented for indexing for deduplication.

### DETAILED DESCRIPTION

Systems and methods disclosed herein build a full-chunk index for deduplication using mostly flash or hard disk drive(s), and only limited RAM. A full-chunk index is an index that maps the hash of every (hence full) “chunk” or block stored in a storage system to (perhaps indirectly) its location. The block hash to physical address table mentioned earlier is an example of a full-chunk index.

Access to the flash is much faster via sequential writes than random writes. Therefore, all updates are via large sequential writes to overcome the challenges (slower speed, greater wear) of using flash for small random writes. In an embodiment, the full-chunk index is stored as a pair of tables, the first of which is stored in RAM, and the second of which is stored in flash. The term “table” is used herein to refer to a hash table, binary search tree, B-tree, or other suitable data structure. Each table maps keys to entries, which contain associated information for the key.

The second table is optimized so that reading an entry takes one (or at most a few) input operations on the flash. Current NAND flash devices allow reads only at the granularity of pages. Today a flash page is typically about 4 kB in size. For example, entries may be aligned to flash page boundaries. Thus, most key lookups take one random read. The systems and methods described herein are substantially faster then conventional systems, and continue to work for a longer time without having to replace or increase the amount of flash.

Although the systems and methods are described herein when using RAM and flash, it is noted that any of a wide variety of different storage technologies may also be implemented, including but not limited to, phase change memory or memristor-based technologies instead of flash, and nonvolatile RAM instead of normal (volatile) RAM. It is also possible to utilize hard drive-based storage instead of flash.

If hard drive-based storage is utilized, then the index latency is much slower. To compensate, most deduplication lookups may be diverted from the full chunk index. For example, the methods described by Zhu, et al. may be employed. ZHU, B., LI, K., and PATTERSON, H. “Avoiding the disk bottleneck in the Data Domain deduplication file system. In Proceedings of the 6th USENIX Conference on File and Storage Technologies,” (FAST) (San Jose, Calif., USA, February 2008), USENIX Association, pp. 269-282. These methods use a Bloom filter and cached fragments of the index to avoid about 99% of the lookups via the full chunk index that would otherwise be required to handle.

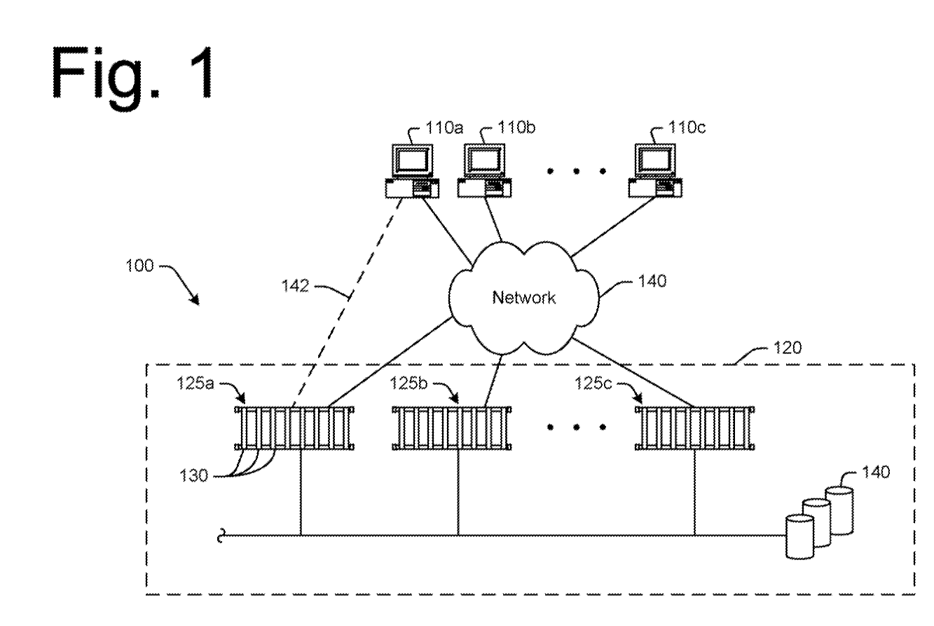

FIG. 1 is a high-level diagram showing an example of a computer system 100 which may use indexing for deduplication. Computer resources are becoming widely used in enterprise environments to provide logically separate “virtual” machines that can be accessed by terminal devices 110a-c, while reducing the need for powerful individual physical computing systems.

The terms “terminal” and “terminals” as used herein refer to any computing device through which one or more users may access the resources of a server farm 120. The computing devices may include any of a wide variety of computing systems, such as stand-alone personal desktop or laptop computers (PC), workstations, personal digital assistants (PDAs), mobile devices, server computers, or appliances, to name only a few examples. However, in order to fully realize the benefits of a virtual machine environment, the terminals may be provided with only limited data processing and storage capabilities.

For example, each of the terminals 110a-c may include at least some memory, storage, and a degree of data processing capability sufficient to manage a connection to the server farm 120 via network 140 and/or direct connection 142. In an embodiment, the terminals may be connected to the server farm 120 via a “front-end” communications network 140 and/or direct connection (illustrated by dashed line 142). The communications network 140 may include one or more local area network (LAN) and/or wide area network (WAN).

In the example shown in FIG. 1, the server farm 120 may include a plurality of racks 125a-c comprised of individual server blades 130. The racks 125a-c may be communicatively coupled to a storage pool 140 (e.g., a redundant array of inexpensive disks (RAID)). For example, the storage pool 140 may be provided via a “back-end” network, such as an inter-device LAN. The server blades 130 and/or storage pool 140 may be physically located in close proximity to one another (e.g., in the same data center). Alternatively, at least a portion of the racks 125a-c and/or storage pool 140 may be “off-site” or physically remote from one another, e.g., to provide a degree of fail-over capability. It is noted, that embodiments wherein the server blades 130 and storage pool 140 are stand-alone devices (as opposed to blades in a rack environment) are also contemplated as being within the scope of this description.

It is noted that the system 100 is described herein for purposes of illustration. Operations may be utilized with any suitable system architecture, and are not limited to the system 100 shown in FIG. 1.

As noted above, the terminals 110a-c may have only limited processing and data storage capabilities. The blades 130 may each run a number of virtual machines, with each terminal 110a-c connecting to a single virtual machine. Each blade 130 provides enough computational capacity to each virtual machine so that the users of terminals 110a-c may get their work done. But because most user machines spend the majority of their time being idle (waiting for the user to provide input), a single blade 130 may be sufficient to run multiple virtual machines. Accordingly, using virtual machines may provide substantial cost savings when compared to giving each individual their own physical machine.

The virtual machines may be instantiated by booting from a disk image including an operating system, device drivers, and application software. These virtual disk images are stored in the storage pool 140, either as files (e.g., each virtual disk image corresponds to a single file in a file system provided by storage pool 140), or a continuous ranges of storage blocks provided by storage pool 140 (e.g., each virtual disk image is stored on a LUN or logical unit provided by a block interface). Each virtual machine has its own virtual disk image.

At least some portions or pieces of these disk images are likely to be shared. For example, multiple virtual machines may use the same device drivers, application software, etc. Accordingly, the storage space needed for each of the individual disk images can also be reduced. One approach for taking advantage of this sharing is to use deduplication, which reduces the total amount of storage needed for the individual disk images.

Deduplication has become popular because as data growth soars, the cost of storing that data also increases, due to the need for more storage capacity. Deduplication reduces the cost of storing multiple logical copies of the same file. Because disk images tend to have a great deal of repetitive data (e.g., shared device drivers), virtual machine disk images lend themselves particularly well to data deduplication.

Deduplication generally refers to the global reduction of redundant data. In the deduplication process, duplicate data is deleted, leaving only one copy of the data to be stored. Accordingly, deduplication may be used to reduce the amount of storage capacity needed, because only unique data is stored. That is, where a data file is stored X times (e.g., in X disk images), X instances of that data file are saved, multiplying the total storage space required by X. In deduplication, however, the data file blocks are only stored once, with each virtual disk image that contains that data file having pointers back to those blocks.

For purposes of illustration, each virtual disk image may include a list of pointers (e.g., one for each logical disk block) to unique storage blocks which may reside in a common storage area. For example, a single printer driver used by ten separate virtual machines may reside in the common storage area, with those ten virtual machine virtual disk images having pointers to the storage blocks where the printer driver actually resides. When one of the virtual machines accesses the printer driver (e.g., for a printing operation), the virtual machine requests the relevant virtual disk blocks, which in turn causes the blade 130 running the virtual machine to request those blocks from the storage pool 140. The storage pool 140 turns those requests into requests for physical disk blocks where the driver resides using the pointers from the relevant virtual disk image, and returns the actual storage blocks to the blade and hence the virtual machine.

Whenever a block is written with content identical to a block already stored, a new copy of the same content is not made. Instead a reference is made to the existing copy. In order to manage this, the system 100 may implement at least one “logical address to physical address” table and a “block hash to physical address” table.

The logical address to physical address table maps the logical addresses that blocks are written to the actual physical addresses in the store where the contents of the block logically at that address is stored. Each virtual disk image may have a corresponding logical address to physical address table. In deduplication, multiple logical addresses may be mapped to the same physical address. For efficiency, these tables may also include a hash of the block being pointed to.

The block hash to physical address table enables the system to determine if contents of a block with a given hash have already been stored, and if so, where that block is. This table often includes additional information such as reference counts for the physical address being pointed to so as to enable “garbage collection” (i.e., removing contents that are no longer being used or no longer being pointed to).

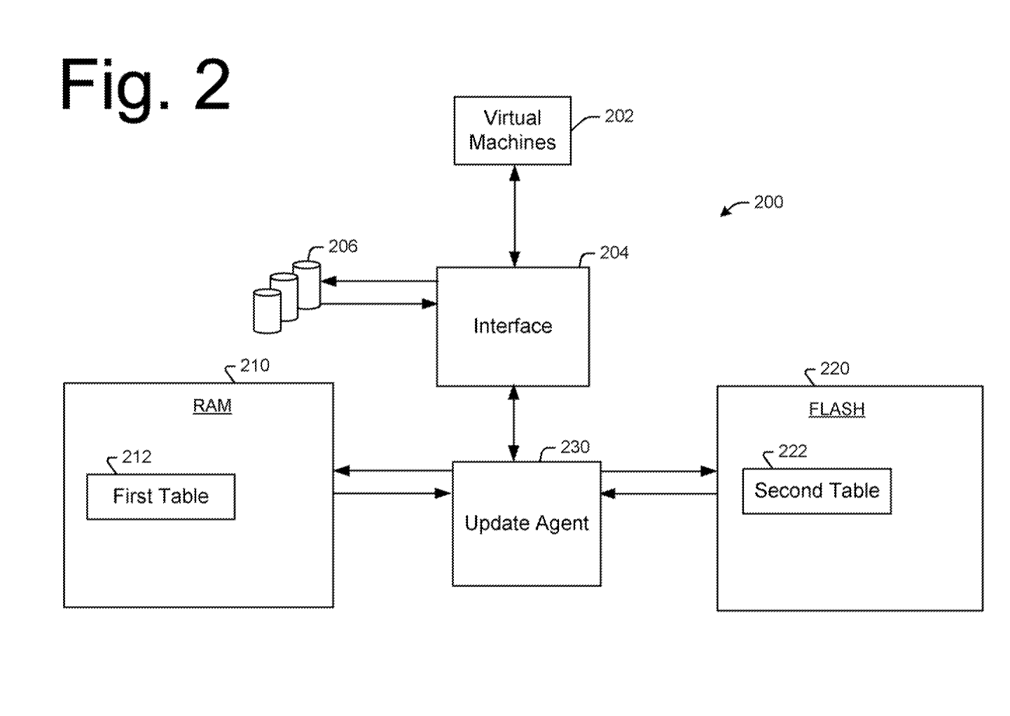

FIG. 2 shows an example software architecture 200 providing indexing for deduplication which may be implemented in the system 100 shown in FIG. 1. The software architecture may interface with one or more virtual machines 202 via an interface 204. The software architecture may implement deduplication for storage 206. It is noted that the term “interface” is used herein to generally describe this component, which may include a file system, RAID controller, etc.

FIG. 2 also shows a first storage 210 (e.g., RAM). First storage 210 may be provided as part of a storage device, or operatively associated with a storage device, for storing a first table 212. A second storage 220 (e.g., flash memory) may also be provided. Second storage 220 may be provided as part of a storage device, or operatively associated with a storage device, for storing a second table 222. The software architecture 200 may comprise an update agent 230 executable to operate on the tables 212 and 222. It is noted that the components shown in FIG. 2 are provided only for purposes of illustration and are not intended to be limiting. Other arrangements are possible, as are different types of memory such as noted above.

The software architecture 200 may be implemented as program code (e.g., firmware and/or software and/or other logic instructions) stored on one or more computer readable medium and executable by one or more processor to perform the operations described below.

The update agent 230 manages the full-chunk index (i.e., the block hash to physical address table). Example operations on a full chunk index include, but are not limited to, lookup a key/hash, and lookup a key/hash and modify an associated entry (including removing it). The following discussion is based on the latter case, as modifying an entry is a superset of the former operation.

In an embodiment, the update agent 230 may be configured to look up a key in the first table 212. If the key is not found in the first table 212, the update agent 230 may look up the key in the second table 222. If the key is found in the second table, the update agent 230 may copy an associated entry for the key from the second table 222 to the first table 212. If the key is not found in the first table 212 and the key is not found in the second table 222, the update agent 230 may insert an entry with the key in the first table 212. The update agent 230 may apply an operation to an entry associated with the key in the first table 212. Finally, when the first table 212 is full, the update agent 230 may merge the data of the first table 212 with the data the second table 222 produce a new version of the second table 212 that replaces a previous version of the second table 222.

The true entry for a given key is considered to “live” in RAM (the first table 212), unless there are no entries for that key in the first table 212. In that case, the true entry for the key lives in the flash (second table 220). If there are no entries for that key in the flash, then the full chunk index has no entry for the key.

When we need to modify an entry, the entry is first copied to RAM (or otherwise created in RAM as needed), and then it is modified in place in RAM. This avoids the need to make a random access change to the flash. Eventually, the RAM fills up (e.g., the first table 212 becomes full), so we move the data of the first table into the much bigger flash table. In general, the second table 222 may be much larger than the first table 212 because flash is less expensive than RAM on a per gigabyte basis.

The second table 222 is updated by sequentially writing out a new version and then switching to the new version. The new version may be created by merging the data from the first and second tables. Afterwards, the first table 212 can be emptied because all of its entries are now in the second table 220.

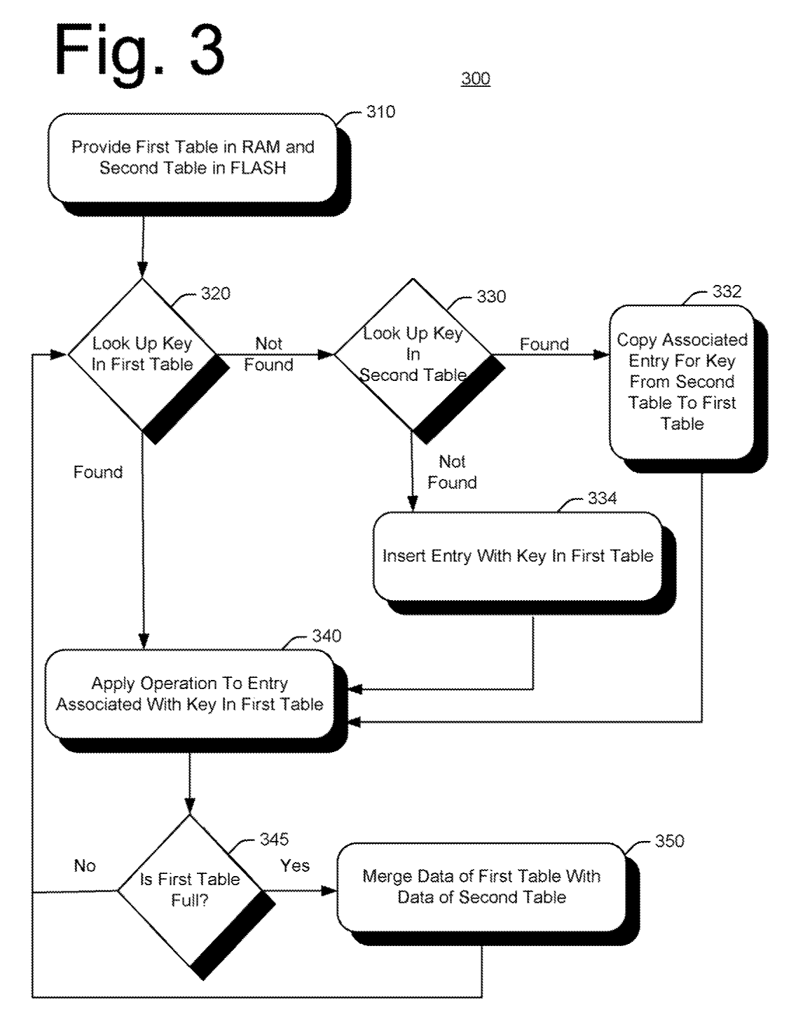

FIG. 3 is a flowchart illustrating exemplary operations which may be implemented for indexing for deduplication. Operations 300 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used.

In operation 310, a first table is provided in a first storage and a second table is provided in a second storage. The first storage may be a random access memory (RAM), and the second storage may be a flash memory. In operation 320, a key is looked up in the first table. If the key is not found in the first table, in operation 330 the key is looked up in the second table. If the key is found in the second table, in operation 332 an associated entry for the key is copied from the second table to the first table. If the key is not found in the first table and the key is not found in the second table, in operation 334 an entry with the key is inserted in the first table.

In operation 340, an operation is applied to an entry associated with the key in the first table. In operation 345, a determination is made whether the first table is full. If not, the modification is finished, and operations may return to operation 320. If yes, then in operation 350, data of the first table is merged with data of the second table to produce a new version of the second table that replaces the previous version of the second table. As before, operations may return to operation 320 to make another modification.

Still other operations and embodiments are also contemplated. By way of illustration, the key may be a hash of a piece of data. In particular, the key may be a hash of a piece of data being deduplicated. The second table may at least map hashes of stored blocks to information identifying where the blocks are stored.

In addition, applying the operation to the entry may include at least one of: incrementing a reference count for a stored block, decrementing a reference count for the stored block, and updating the information for the stored block. If decrementing the reference count produces a new reference count of zero, then that block and/or entry may be explicitly or implicitly marked for deletion.

The first storage may be a static or dynamic random access memory (SRAM or DRAM) and the second storage may be a flash memory. The first storage may be a static or dynamic random access memory (SRAM or DRAM) and the second storage may be at least one hard disk drive.

Merging the data of first table with the data of the second table may further include producing the new version of the second table from entries of the second table associated with keys not in the first table and the entries of the first table, and emptying the first table. That is, when there is an entry for a given key in both the first table 212 and the second table 222, the new version of the second table 222 may include for that key at most only the entry from the first table 212. The information for that key in the second table 222 is ignored. Entries of the first table marked for deletion may not be included in the new version of the second table. That is, when the entry for a given key in the first table 212 is marked for deletion, the resulting new version of second table 222 may contain no entries for that key.

Merging the data of first table with the data of the second table may further include sequentially writing out the new version of the second table to the second storage.

Looking up the key in the second table may be by reading only a single page from the second storage with a high probability. The update agent may determine which page to read from the second storage by using a hash. The hash may be a hash of the key or the key itself (e.g., if the key is the hash of a piece of data). For example, the second table may be organized as a hash table with flash page-size buckets (aligned to flash page boundaries) indexed by the first N bits of the keys. If the hash table is sized sufficiently large relative to the expected number of entries, most lookups will initially read a non-full bucket and thus terminate having read only a single page from the second storage. Rarely, the read bucket may be full and an overflow page may be consulted. Some overflow pages may be cached in RAM to guard against hotspots.

It is noted that one having ordinary skill in the art will realize, after becoming familiar with the teachings herein, that there are many other ways of implementing the second table 222 so that lookup reads only a single page from the second storage with high probability. Ideally, the method chosen will also be highly space efficient as well.

Looking up the key in the second table may include maintaining a data structure in the first storage that enables identifying a page of the second storage containing any entry of the second table associated with a given key, using the data structure and without accessing the second storage. For example, the second table 222 may be organized as a sorted list where entries are stored in ascending order of their associated keys and the data structure in the first storage may contain the lowest key associated with the entries in each flash page. A simple binary search of the data structure in the first storage (which needs no access to the second storage) determines the page that includes any entry for a given key. Merging in this case is particularly simple, and can be accomplished by sorting the first table (if needed) and then performing a straightforward merge of the two sorted tables.

Further operations may include providing a third table in the second storage; merging the second table with the third table when the second table is full to produce a new version of the third table to replace a previous version of the third table; and emptying the second table. The invention may be applied twice to further reduce the amount of RAM required. To illustrate, the invention may be applied to the first table (refer to the original or logical version as “X”), producing a new first table X and a second table X, with the first table X placed in the first storage, and the second table X placed in the second storage. There are thus three resulting tables: a first table X, a second table X, and the original second table. Together, the first table X and the second table X contain the data that the original first table would have contained.

If the ratio between the size of a first table and the size of a second table is ten, for example, then applying the invention twice results in a ratio between the RAM and flash usage of 10*10 or 100. Of course, as is, this requires two flash reads instead of just one per lookup most of the time. However, this can be reduced to a single flash read per lookup by maintaining a Bloom filter in RAM for the keys of the second table X, to avoid reading from that table in almost every case that that table does not contain an entry for the given key. Note that if that table does contain an entry, then the original second table is not read.

When a key is being looked up, rather than modified, the procedure is similar to that shown in FIG. 3. Step 332 is optional here, as it improves read latency should a key be accessed again soon at the cost of having to write to flash sooner due to the first table filling up earlier. Steps 334, 340, 345, and 350, do not apply. If an entry is found, then it is read. An exception is that if the found entry is marked for deletion, then the lookup may act as if no entry was found.

In an embodiment, a first table is provided in RAM that can hold 1/alpha the total number of index entries. It is noted that the lookup & modification procedure for a single key may be executed with at most a single random read to the flash and a limited number of sequential writes to the flash. The number of sequential page writes per entry modification is bounded above by alpha/p, where p is the number of entries per flash page: if a*p entries can be held in the first table in RAM, and b*p entries can be held in the in second table in flash, then there need be no more than b writes every a*p operations. That is, b/a*p=(b/a)/p=alpha/p, since b/a=alpha.

For purposes of illustration, an example flash page may have a size of 4 kB, and an entry size of 32 bytes. Accordingly, p=4096/32=128. Thus, if alpha=128 for 1 page write per modification/insert, an extra 0.64 GB of RAM is needed, in addition to the 64 GB of flash per 8 TB of disk, for the same number of write operations. But these are made faster as sequential writes to the flash.

The above example is only provided for purposes of illustration and is not intended to be limiting. Other embodiments are also contemplated.

In another embodiment, the full chunk index may be partitioned into subindexes, each of which has a first table and a second table and implements the operations described herein. This may reduce the latency by speeding up the merge step as less data must be moved. It may also allow the index to be distributed across multiple systems.

In another embodiment, a mode may exist where deduplication is suboptimal, resulting in some duplication of data. To handle this, the full chunk index may for some keys list information about multiple locations where copies of the associated block are located. This may be accomplished by making entries longer so they can keep this information directly; by providing entries with overflow pointers when the entries do not fit in their slot; or by allowing multiple entries to have the same key.

If two entries have the same key (e.g., due to duplicated blocks), all the entries can be treated as a single set and can be copied to the flash index when any of entries need to be modified. Before continuing, it is also noted that the systems and architecture described above with reference to FIGS. 1 and 2 are illustrative of various example embodiments, and are not intended to be limiting to any particular components or overall architecture.

The operations shown and described herein are provided to illustrate exemplary embodiments. It is noted that the operations are not limited to the ordering shown. Still other operations may also be implemented.

By way of illustration, operations may further include skipping writing entries with a reference count of zero from the first table to the new version of the second table. Operations may further include sorting or keeping sorted the second table by key. Operations may further include caching overflow pages for the second table in the first storage.

It is noted that the exemplary embodiments shown and described are provided for purposes of illustration and are not intended to be limiting. Still other embodiments are also contemplated.

1. A method of indexing for deduplication, comprising:
providing a first table in a first storage and a second table in a second storage;
looking up a key in the first table, and:
if the key is not found in the first table, looking up the key in the second table;
if the key is found in the second table, copying an associated entry for the key from the second table to the first table;
if the key is not found in the first table and the key is not found in the second table, inserting an entry with the key in the first table;
applying an operation to an entry associated with the key in the first table; and
merging data of the first table with data of the second table when the first table is full to produce a new version of the second table that replaces a previous version of the second table.

2. The method of claim 1, wherein the key is a hash of a piece of data.

3. The method of claim 2, wherein the second table at least maps hashes of stored blocks to information identifying where the blocks are stored.

4. The method of claim 3, wherein applying the operation to the entry includes at least one of: incrementing a reference count for a stored block, decrementing a reference count for the stored block, and updating the information for the stored block.

5. The method of claim 1, wherein the first storage is a static or dynamic random access memory (SRAM or DRAM) and the second storage is a flash memory.

6. The method of claim 1, wherein the first storage is a static or dynamic random access memory (SRAM or DRAM) and the second storage is at least one hard disk drive.

7. The method of claim 1, wherein merging the data of first table with the data of the second table further comprises:
producing the new version of the second table from entries of the second table associated with keys not in the first table, and the entries of the first table; and
emptying the first table.

8. The method of claim 7, wherein entries of the first table marked for deletion are not included in the new version of the second table.

9. The method of claim 7, wherein merging the data of first table with the data of the second table further comprises:
sequentially writing out the new version of the second table to the second storage.

10. The method of claim 1, wherein looking up the key in the second table is by reading only a single page from the second storage with a high probability.

11. The method of claim 10, wherein looking up the key in the second table further comprises:
maintaining a data structure in the first storage;
identifying a page of the second storage containing any entry of the second table associated with the key, using the data structure and without accessing the second storage;
reading the identified page of the second storage from the second storage.

12. The method of claim 1, further comprising:
providing a third table in the second storage;
merging the second table with the third table when the second table is full to produce a new version of the third table to replace a previous version of the third table; and
emptying the second table.

13. A system comprising:
a first storage for storing a first table;
a second storage for storing a second table;
an update agent configured to look up a key in the first table, and:
if the key is not found in the first table, look up the key in the second table;
if the key is found in the second table, copy an associated entry for the key from the second table to the first table;
if the key is not found in the first table and the key is not found in the second table, insert an entry with the key in the first table;
apply an operation to an entry associated with the key in the first table; and
wherein data of the first table is merged with data of the second table when the first table is full to produce a new version of the second table that replaces a previous version of the second table.

14. The system of claim 13, wherein the first storage is a random access memory (RAM) and the second storage is one of a flash memory, a memrister-based memory, and a phase change memory.

15. The system of claim 13, wherein the data of the first table is merged with the data of the second table by:
producing the new version of the second table from entries of the second table associated with keys not in the first table, and the entries of the first table; and
emptying the first table.

16. The system of claim 13, wherein the update agent when looking up the key in the second table determines a page to read from the second storage using a hash.

17. The system of claim 13, wherein the data structure of the second table uses overflow pages.

18. The system of claim 13, wherein the second storage includes at least a third table, wherein the data of the second table is merged with the data of the third table when the second table is full to produce a new version of the third table that replaces a previous version of the third table.

19. The system of claim 13, wherein entries with a reference count of zero are not included in the new version of the second table.

20. The system of claim 13, wherein the key is a hash of a piece of data being deduplicated.
